(19) United States
(12) Patent Application Publication
(10) Pub. No.: US 2007/0224885 A1
(43) Pub. Date: Sep. 27, 2007

(54) MODULAR PANEL ASSEMBLY

(75) Inventor: Ronald McCarthy, Toronto (CA)

Correspondence Address: BERESKIN AND PARR, 40 KING STREET WEST, BOX 401, TORONTO, ON, M5H 3Y2, CA

(73) Assignee: Borrowed Spaces Inc., Toronto (CA)

(21) Appl. No.: 11/734,306

(22) Filed: Apr. 12, 2007

Related U.S. Application Data
(63) Continuation-in-part of application No. 11/467,673, filed on Aug. 28, 2006.
Application No. 11/467,673 is a continuation-in-part of application No. 11/372,023, filed on Mar. 10, 2006.

(51) Int. Cl. H01R 13/648

(52) U.S. Cl. 439/608

(57) ABSTRACT

The modular panel assembly comprises a plurality of different design inserts that can be readily assembled into a panel using a plurality of structural members. The different kinds of design inserts and structural members have the same type of coupling mechanism so as to allow many different configurations based on insert members of many different appearances.

### RELATED APPLICATION

This application claims the benefit of, and is a continuation-in-part of, U.S. patent application Ser. No. 11/372,023, filed Mar. 10, 2006 and U.S. patent application Ser. No. 11/467,673, filed Aug. 28, 2006, the entire contents of both of which are hereby incorporated by reference.

### FIELD OF THE INVENTION

This invention relates to a modular panel assembly.

### BACKGROUND OF THE INVENTION

Panels are used in a variety of different contexts for both functional and aesthetic reasons. For example, garden structures may include decorative panels to provide enclosed areas for privacy and to create special areas of interest, such as a space in and around a garden, patio or deck. Garden structures containing panels may also be used to define an entranceway. Garden structures containing panels may also act as a trellis for vines and other creeping plants.

Many panel configurations are designed with a specific pattern or style in mind. For example, in an ideal situation, the design of the garden structure containing a panel configuration will reflect the unique character of the garden or the personal taste of the garden owner. Thus, in many cases, it is desirable if the garden paneling is custom-built to specific design requirements. Such design requirements include the style, size and ornamental appearance of the garden panels.

### SUMMARY OF THE INVENTION

In accordance with an aspect of an embodiment the invention, there is provided a modular panel assembly. The modular panel assembly comprises a plurality of structural members for assembling to define a plurality of insert receiving spaces, wherein the plurality of structural members comprise a plurality of structural couplers for each insert-receiving space in the plurality of insert-receiving spaces. The modular panel assembly further comprises a plurality of design inserts of a plurality of different design insert kinds, wherein each design insert kind in the plurality of different design insert kinds has a distinct appearance; and, each design insert of the plurality of design inserts i) is receivable into a corresponding insert-receiving space in the plurality of insert-receiving spaces, ii) is of a corresponding design insert kind in the plurality of different design insert kinds, and, iii) comprises a configuration of design members to provide the distinct appearance of the corresponding design insert kind, the configuration of design members having a plurality of insert couplers for mating with the plurality of structural couplers to secure the design insert in the corresponding insert-receiving space. When different design inserts are of different corresponding design insert kinds, the configurations of the different design members differ to provide the distinct appearances of the corresponding design insert kinds. The plurality of structural couplers and the plurality of insert couplers comprise a plurality of male members and a plurality of female members for mating with the plurality of male members.

In accordance with a further aspect of a yet further embodiment of the invention, there is provided a modular panel assembly comprising; a) a plurality of structural members for assembling to a define an insert-receiving space, wherein the plurality of structural members comprise a plurality of resilient members projecting into the insert-receiving space; and b) a design insert for insertion into the insert-receiving space, the design insert having a plurality of grooves for receiving the plurality of resilient members to secure the design inserts in the corresponding insert receiving space.

### BRIEF DESCRIPTION OF THE DRAWINGS

A detailed description of preferred embodiments of the present invention is provided herein below with reference to the drawings, in which:

FIG. 1(a) illustrates, in a front view, a panel assembly in accordance with an embodiment of the present invention;

FIG. 1(b), in a front view, illustrates a panel assembled from the modular panel assembly of FIG. 1(a);

FIGS. 2(a), 2(b), 2(c), 2(d), 2(e), 2(f), 2(g), 2(h) and 2(i) are front views of different panels (design inserts not shown) assembled from a modular panel assembly in accordance with an embodiment of the invention;

FIGS. 3(a), 3(b), 3(c), 3(d), 3(e) and 3(f) are front views of lattice-type design inserts with external frames;

FIGS. 3(g) and 3(h), in perspective views, illustrate representative design inserts with, and without an external frame respectively;

FIGS. 3(i), 3(o), 3(k), 3(l), 3(m) and 3(n) are front views of lattice-type design inserts without external frames;

FIGS. 4(a), 4(b), 4(c), and 4(d) are front views of design inserts of the open, arch, crossbeam, and full panel type;

FIGS. 5(a) and 5(b) are front views of design inserts of differing dimensions;

FIG. 6 is a top view of a stile mating with a design insert in accordance with an aspect of an embodiment of the invention;

FIG. 7 is a front view of a design insert with a lip of a modular panel assembly in accordance with an aspect of an embodiment of the present invention;

FIG. 8 is a cross-sectional view of the design insert of FIG. 7 at line A-A of FIG. 7;

FIG. 9 is a top view of a stile mating with the design insert of FIG. 7;

FIG. 10 is cross-sectional view at line B-B of FIG. 9;

FIG. 11 is a front view of a corner of an assembled modular panel in accordance with an embodiment of the invention;

FIG. 12 is a top view of the corner of the assembled modular panel of FIG. 11;

FIG. 13(a) and 13(b) show a top view and side view of a mullion of a modular panel assembly in accordance with an aspect of an embodiment of the present invention;

FIGS. 14(a) and 14(b) show top views of a connection between a structural member and a design insert.

FIG. 15 is a front view of the panel in FIG. 1 as part of a garden architectural system.

FIG. 16, in an exploded perspective view, illustrates a modular panel assembly in accordance with a further embodiment of the invention.

FIG. 17(a), in a schematic view, illustrates the modular panel assembly of FIG. 16.

FIGS. 17(b) and 17(c) illustrate expanded views of portions of the modular panel assembly of FIG. 17(a).

### DETAILED DESCRIPTION OF EMBODIMENTS OF THE INVENTION

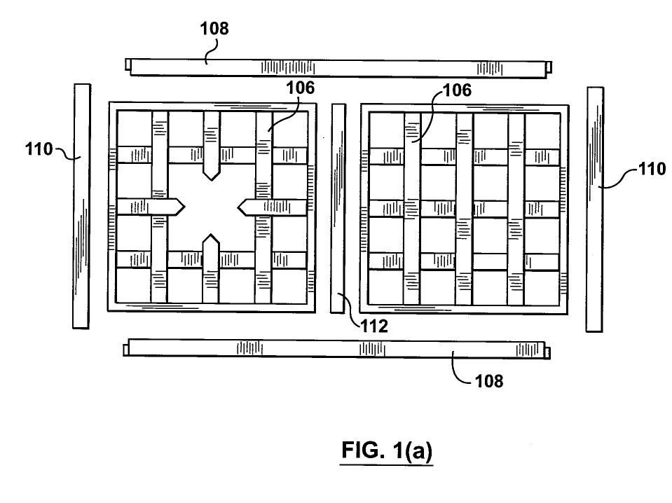

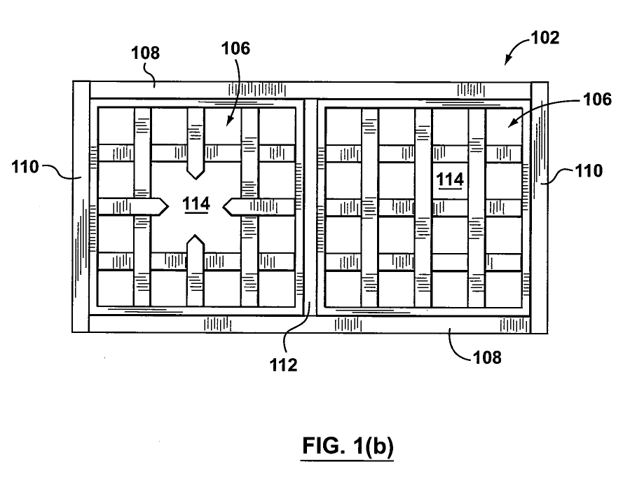

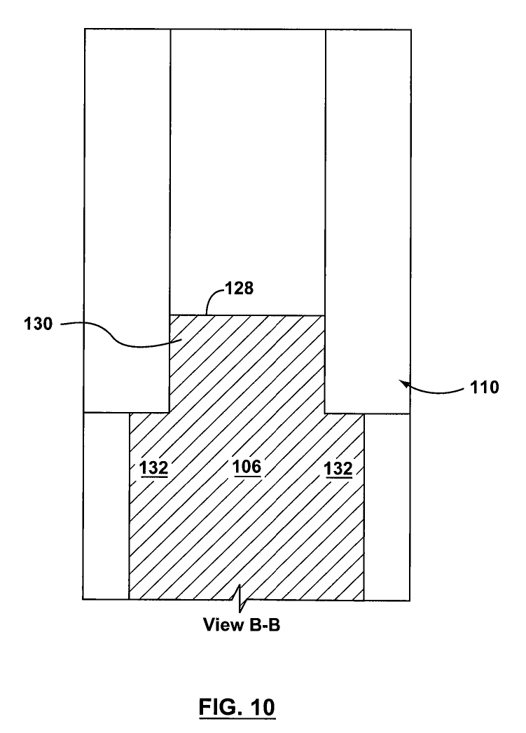

Referring to FIG. 1(a), there is illustrated in a front view, some of the different components of a modular panel assembly 100 in accordance with an embodiment of the invention. Referring to FIG. 1(b), there is illustrated in a front view, a panel 102 that has been assembled from the modular panel assembly 100 of FIG. 1(a). As shown in FIG. 1(a), the modular panel assembly 100 comprises two different types of components: structural members and design inserts 106. Structural members comprise rails 108, stiles 110 and at least one mullion 112. These structural members are assembled to provide two insert-receiving spaces 114 shown in FIG. 1(b). The two design inserts are attached to the structural members and are located inside the two insert-receiving spaces 114. Each structural member has the same kind of structural coupler for mating with insert couplers of the design inserts 106. Examples of suitable structural couplers and insert couplers are described below with reference to FIGS. 10 to 13.

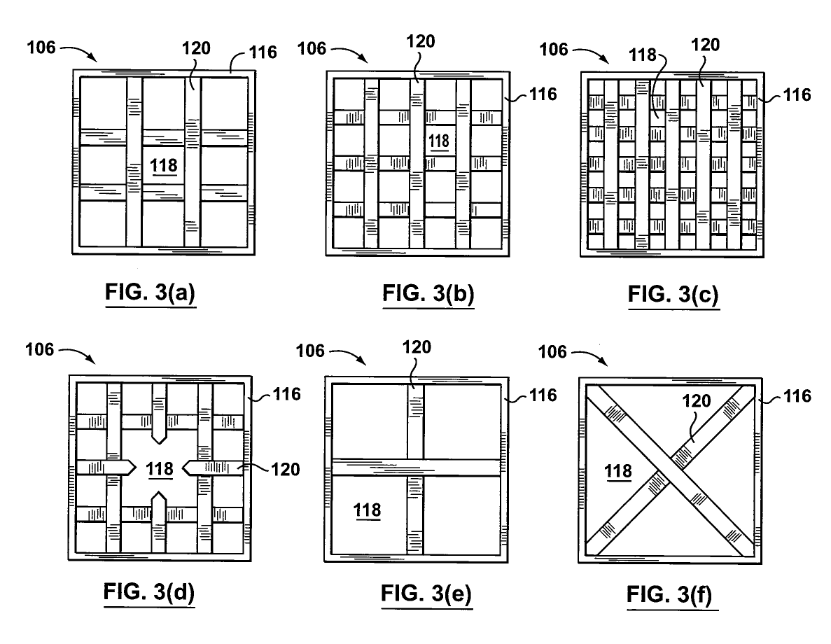

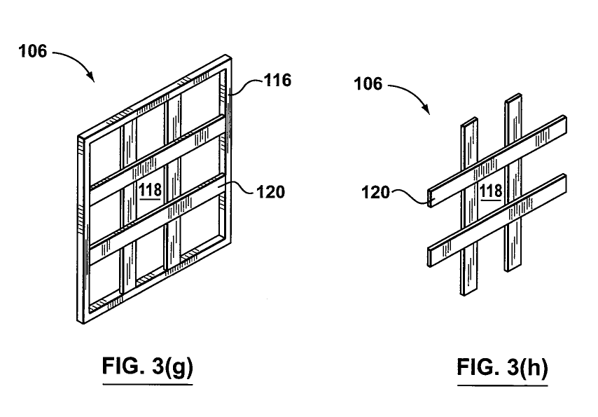

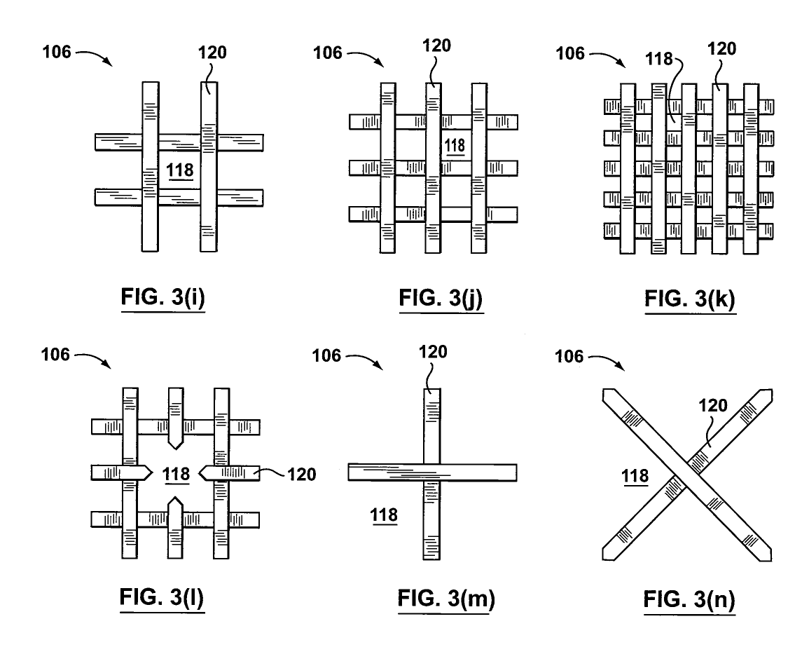

The panel 102 illustrated in FIG. 1(b) is merely one example of many different panels that may be constructed using modular panel assemblies in accordance with different aspects of different embodiments of the invention. Similarly, the modular panel assembly 100 shown in FIG. 1(a) would typically include many additional components that could be used to assemble panels. For example, modular panel assemblies in accordance with different aspects of the invention may include structural members of many different dimensions to define insert-receiving spaces 114 of different dimensions that can accommodate design inserts 106 of different dimensions. Many different types of design inserts included in modular panel assemblies in accordance with aspects of embodiments of the invention are illustrated in FIGS. 3(a) to 3(n), 4(a) to 4(d), 5(a) and 5(b). All of these structural members, however, use a common structural coupler, and all of the design inserts 106 also use a common insert coupler, such that different panels of widely varying appearance may readily be constructed using the modular panel assembly 100.

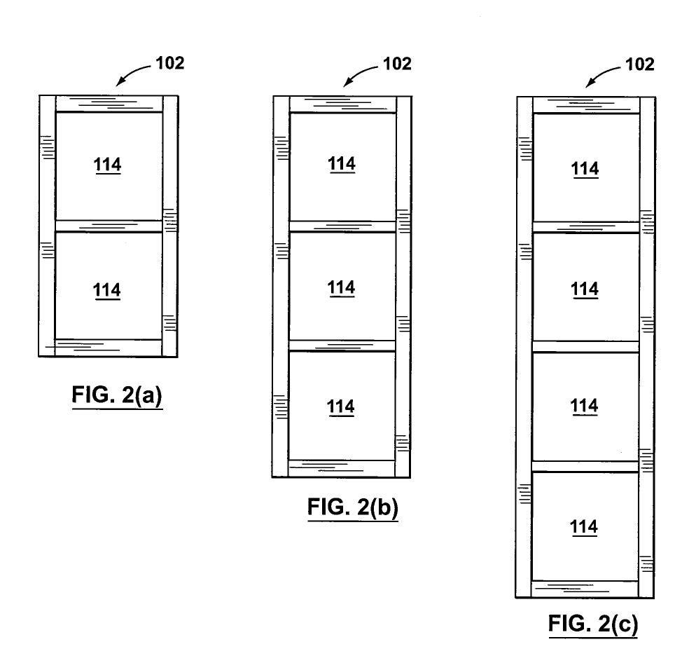

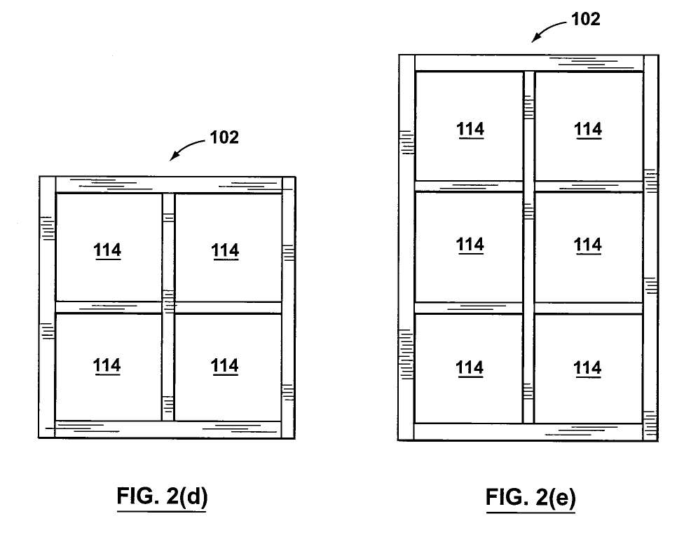

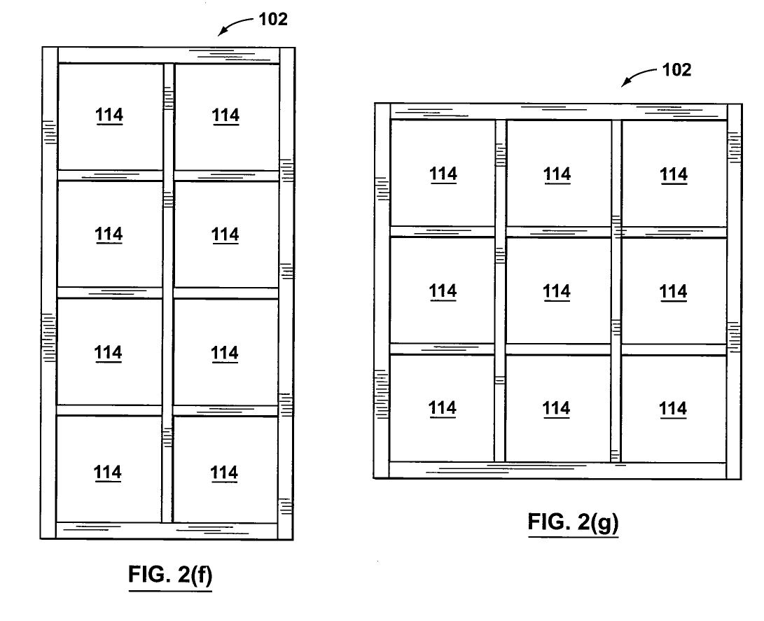

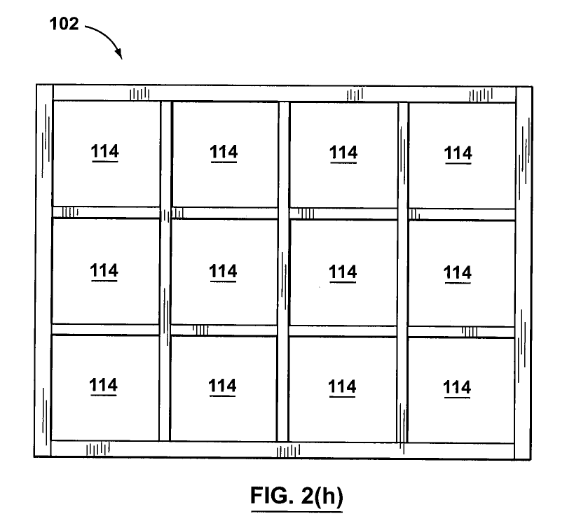

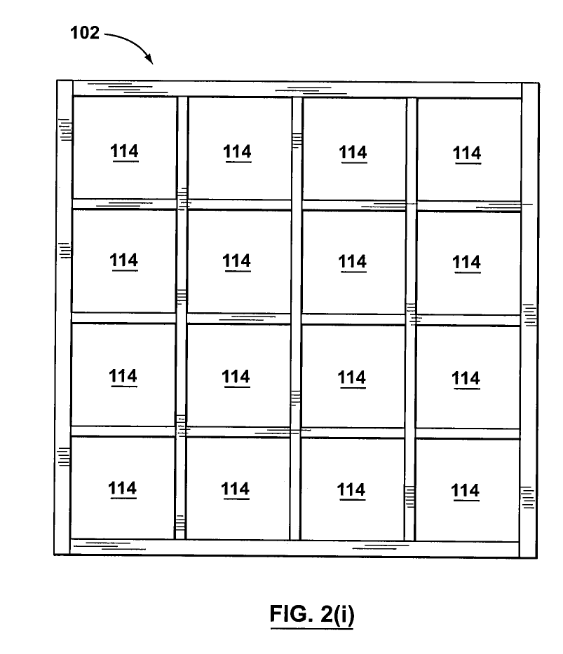

Referring to FIGS. 2(a) to 2(i), different examples of panels 102 that can be assembled from modular panel assembly 100 are illustrated in front views. Design inserts 106 are not shown inserted into the insert-receiving spaces 114 of these panels. The shape and size of each panel 102 is based on the number of insert-receiving spaces 114, as well as the shape and size of each of these insert-receiving spaces 114. Put another way, the shape and size of each panel 102 is based on the number of design inserts 106 that such panel can receive. For example, FIG. 2(a) shows a panel 102 that can receive two different design inserts (not shown) in insert-receiving spaces 114. The panel 102 of FIG. 2(a) can be described as having a one-by-two configuration in that the panel is able to receive one design insert in one direction and two design inserts in the other direction.

FIG. 2(b) shows a panel 102 that can receive three different design inserts (not shown) in insert-receiving spaces 114. FIG. 2(c) shows a panel 102 that can receive four different design inserts (not shown) in insert-receiving spaces 114, which have a one-by-four configuration. FIG. 2(d) shows a panel 102 that can receive four different design inserts (not shown) in insert receiving spaces 114. In this example, the panel can be described to be in a two-by-two configuration. FIG. 2(e) shows a panel 102 that can receive six different design inserts (not shown) in insert receiving spaces 114, which have a two-by-three configuration. FIG. 2(f) shows a panel 102 that can receive eight different design inserts (not shown) in insert receiving spaces 114, which have a two-by-four configuration. FIG. 2(g) shows a panel 102 that can receive nine different design inserts (not shown) in insert receiving spaces 114. In this example, the panel 102 is in a three-by-three configuration. FIG. 2(h) shows a panel 102 that can receive twelve different design inserts (not shown) in insert receiving spaces 114, which have a four-by-three configuration. FIG. 2(i) shows a panel 102 that can receive sixteen different design inserts (not shown) in insert receiving spaces 114. In this example, the panel is in a four-by-four configuration.

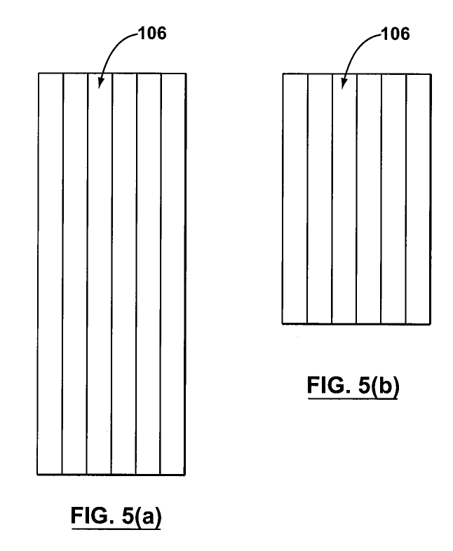

As described above, the structural members may be of different lengths. For example, the length of the stiles 110 are longer in FIG. 2(b) than in FIG. 2(a). In addition, it will be appreciated by those of skill in the art, that the panel 102 may be of many different shapes and configurations. Further variations of the shape and configuration of panel 102 are discussed with reference to FIGS. 5(a) and 5(b).

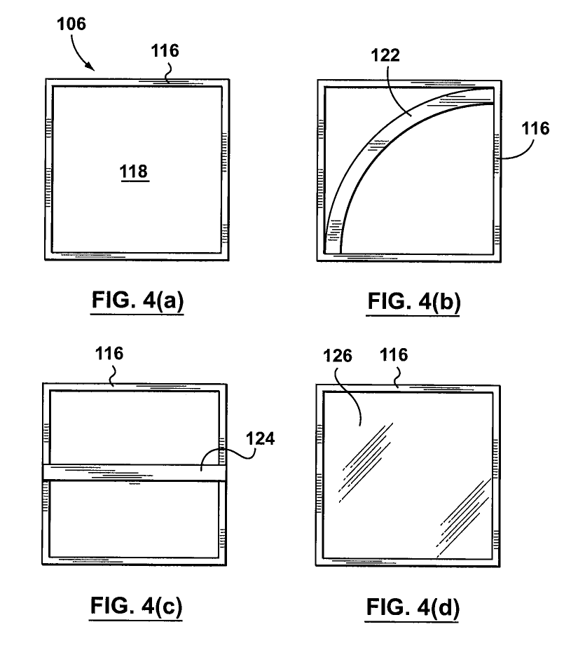

Referring to FIGS. 3(a) to 4(d), different kinds of design inserts 106 included in assembly 100 are shown. Each different kind of design insert 106 has a distinct appearance due to a distinct configuration of its design members. The design members can include an external frame 116 that surrounds an internal design area 118. In most kinds of design inserts 106, the internal design area 118 will also include additional design members.

Referring specifically to FIGS. 3(a) to 3(f), six different kinds of design inserts 106 are shown. All of these design inserts 106 include variants of a lattice-type internal member 120 that extends into the internal design area 118 from the external frame 116. In FIGS. 3(e) and 3(f) different variants of the lattice-type internal member 120 divide the internal design area 118 into at least four openings. In the design inserts 106 of FIGS. 3(a) to 3(d) the different variants of the lattice-type internal member 120 divide the internal design area into more than four openings.

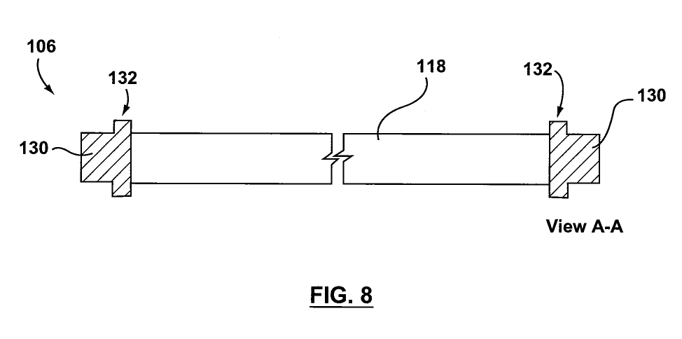

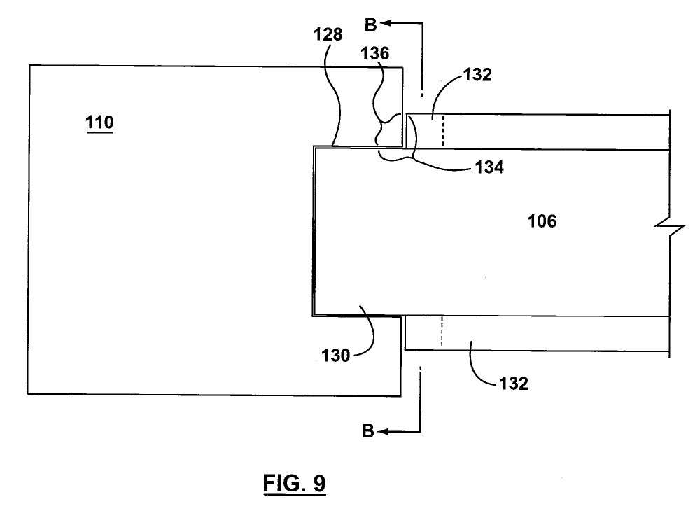

FIG. 3(g) shows the design insert 106 of FIG. 3(a) in a perspective view. As described above, the design insert 106 consists of external frame 116, internal design area 118, and lattice-type internal members 120. In this configuration, the internal couplings (as shown in FIGS. 8 and 9) are part of the external frame 116. In contrast, FIG. 3(h) shows a perspective view of an alternate embodiment of the design insert 106. In this embodiment the design insert 106 only consists of internal design area 118 and lattice-type internal members 120. The lattice-type internal members 120 are attached to each other with an appropriate fastening means (not shown) such that they can retain their relative position, orientation, and structural integrity without the need for an external frame 116. In this configuration, the internal couplings (as shown in FIGS. 8 and 9) are provided by the ends of the lattice-type internal members 120, such that a design insert 106 without external frame 116 can be compatible with the common structural couplings of the structural members (shown in FIG. 1).

Referring specifically to FIGS. 3(i) to 3(n), six different kinds of frameless design inserts 106 are shown. All of these design inserts 106 include variants of lattice-type internal member 120 that extends into the internal design area 118 without the support of external frame 116. In FIGS. 3(i) and 3(n) different variants of the lattice-type internal member 120 divide the internal design area 118 into at least four openings.

FIG. 4(a) shows a design insert 106 that consists only of an external frame 116, without an internal member, leaving the entire internal design area 118 open. FIG. 4(b) shows a design insert 106 in which the internal member is a curved member 122 for dividing the internal design area 118 into two openings of unequal area. FIG. 4(c) shows a design insert 106 in which the internal member is a straight member 124 for dividing the internal design area 118 into two openings. FIG. 4(d) shows a design insert 106 in which the internal member is an extended member 126 that completely covers the internal design area 118. Of course, it will be appreciated by those of skill in the art, that the design inserts 106 may have many different configurations in addition to those described above.

The design inserts 106 may also be of different sizes. FIGS. 5(a) and 5(b) illustrate two examples of design inserts 106 of the type shown in FIG. 4(d), that have different sizes. The dimensions of the two design inserts shown in FIGS. 5(a) and 5(b) also differ from the dimensions of the design inserts of FIGS. 3(a) to 4(d), which are approximately one-third the size of the design insert of FIG. 5(a) and approximately one half the size of the design insert of FIG. 5(b). As described above, the structural members are of different dimensions and can thus be assembled to form insert-receiving spaces 114 that are capable of accommodating design inserts of many different sizes.

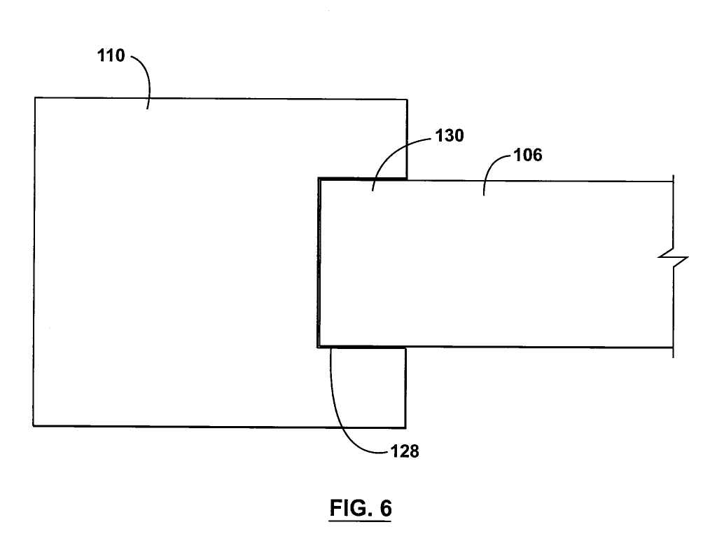

Reference is now made to FIG. 6, which illustrates the top view of a structural member mating with a design insert 106 in accordance with an embodiment of the invention. The structural member shown is the stile 110. However, the configuration of the structural coupler is the same for all structural members of the panel assembly 100. In other words, the structural coupler of the stile 110 shown in FIG. 6 is representative of all structural members of this embodiment. Further, the insert coupler, and the manner in which it mates with the structural coupler, as shown in FIG. 6, is representative of all design inserts 106 of this embodiment. In the embodiment shown, each structural coupler comprises a groove 128 and each insert coupler comprises an edge 130 of the external frame 116. The dimension of groove 128 is selected to engage with the edge 130. The selected dimension of the groove 128 and edge 130 can be any suitable dimension. As described below in connection with FIG. 8, the external frame 116, of framed design inserts 106 may also include a lip 132. However, in the embodiment of FIG. 6, the design insert 106 does not include a lip.

In general, the structural couplers of all of the structural members are capable of mating, and are dimensioned to engage, with any of the insert couplers of the design inserts 106. It should be noted that many different coupling mechanisms can be used as long as they can be universally applied to all structural and insert members as described above. In some embodiments, the structural and insert couplers are symmetrically located on the structural members and design inserts, respectively. This allows certain structural members and insert members to be used in more than one manner, making them more versatile and easier to assemble, which is especially helpful to reduce inventory costs. For example, the same stile and the same rail could be used on either side of the panel 102. Furthermore, in other embodiments, the groove can be provided on the design inserts, while the edge is provided on the structural members.

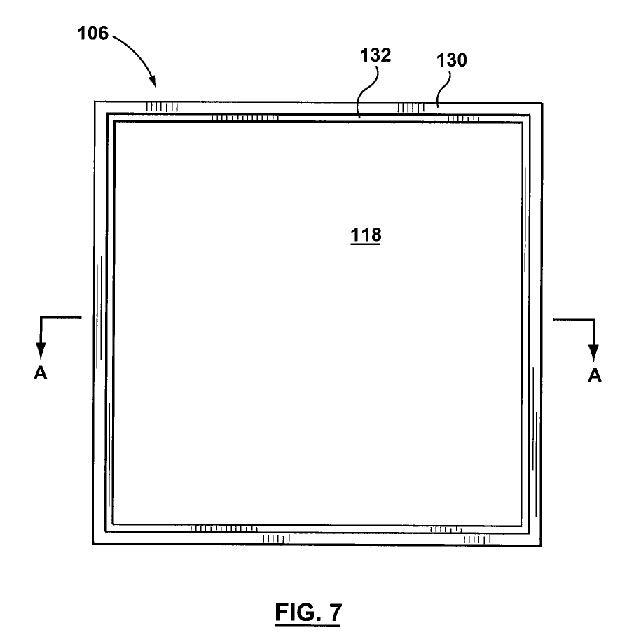

Reference is now made to FIG. 7, which illustrates a front view of an embodiment of a design insert 106 (internal design area 118 is not shown). In this embodiment, the design insert 106 comprises lip 132 on each side of the edge 130 of the external frame 116. FIG. 8 further illustrates the design insert 106 of FIG. 7 along a cross-sectional view at line A-A of FIG. 7. According to one method of manufacturing this embodiment of the invention, the design insert 106 is initially provided with an unformed edge. That is, the edge does not include a lip. Then, the finished edge is formed from the unformed edge by cutting away a portion of the unformed edge to provide the lip such that the formed edge is dimensioned to engage with the groove 128. In some cases, portions of the lattice-type internal members 120 may also be cut away such that the edges are flush with the lip. For example, in the case of the lattice member shown in FIG. 3(f), the width of these X members will, in one embodiment, be the same as the width of the structural members. As shown in FIG. 3(f), each end of the X member fits into a corner of the design insert 106. According to one method of assembly, the X members are fit into the design insert 106 before the edge is formed. Thus, when the edge is being formed on the design insert 106, portions of the ends of the X members will also be cut away such that they align with the lip. Of course, other lattice-type internal members may have a width that is no greater than the width of the formed edge.

FIG. 9 illustrates a top view of stile 110 mating with a design insert 106 of FIGS. 7 and 8. The lip 132 and edge 130 of the design insert 106 define a non-planar sealing surface 134 for abutting a corresponding sealing surface 136 along the groove 128 of the stile 110. In general, the non-planar sealing surface 134 of the design insert 106 abuts the corresponding sealing surface 136 along the structural members to which the design insert 106 is attached. The lip 132 can serve to provide a more finished look by hiding the groove 128 and edge 130 from view. In addition, the lip 132 can help impede moisture from leaking between the groove 128 and edge 130.

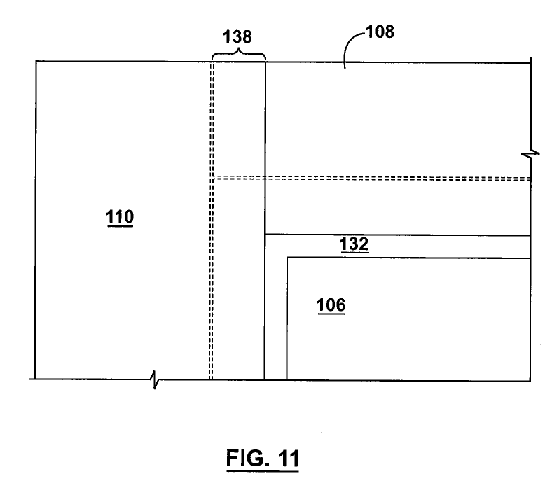

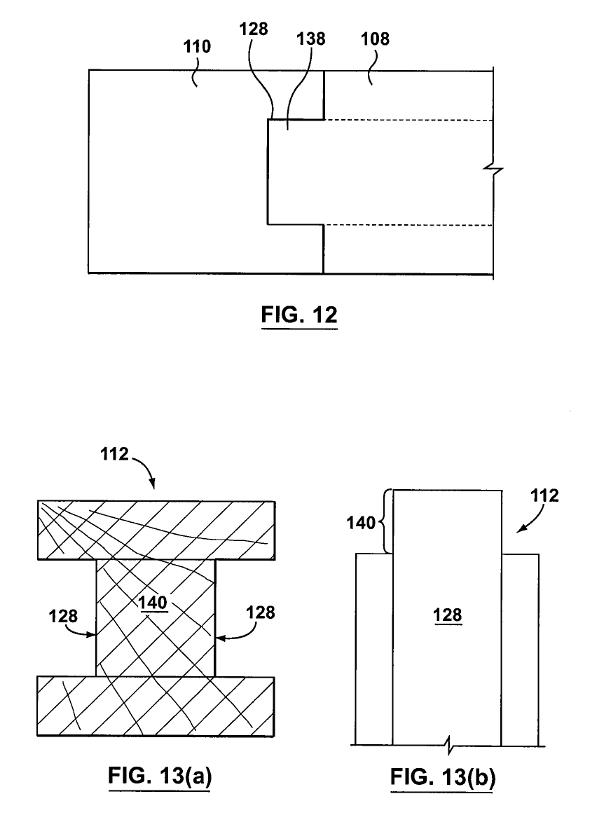

Reference is now made to FIG. 10, which shows a side view of stile 110 mating with design insert 106 at line B-B of FIG. 9. The edge 130 of design insert 106 mates with the groove 128 of stile 110. Reference is also made to FIG. 11, which shows a front view of FIGS. 9 and 10, with the addition of rail 108. As shown, rail 108 mates with design insert 106 in the same manner that stile 110 mates with design insert 106. In addition, rail 108 mates with stile 110. More specifically, rail 108 comprises an end protrusion 138 on both ends of the rail and each protrusion mates with the end parts of the groove 128 of each stile 110. FIG. 12 shows a top view of the connection of end protrusion 138 of the rail 108 and groove 128 of stile 110. It should be noted that the opposite rail 108 connects to the stiles 110 in the same manner as the above-described rail 108.

Generally, the structural members consist of both external and internal members. However, it is possible that the structural members of an actual panel 102 may consist only of external members. The external members, which comprise rails 108 and stiles 110, are assembled to provide a structural frame having an internal perimeter. In some embodiments, the structural couplers of the external members are grooves 128. Therefore, when the structural members are assembled to make an insert receiving space 114, a groove 128 runs along the internal perimeter of the structural frame.

In some embodiments, mullion 112 is an internal member for extending across the internal perimeter of the external frame. FIG. 13(a) and 13(b) illustrate a top and side view, respectively, of a mullion 112. At each end of the mullion 112, there is an end protrusion 140 dimensioned to mate with the groove 128 along the internal perimeter of structural frame. As a structural member, mullion 112 also comprises two structural couplers that mate with the insert couplers of at least two design inserts 106 (not shown), one on each side. This structural coupler consists of two grooves 128 that are of a selected dimension that allows them to mate with edge 130 (See FIG. 6) of a design insert 106. Grooves 128 runs along each side of the mullion 112.

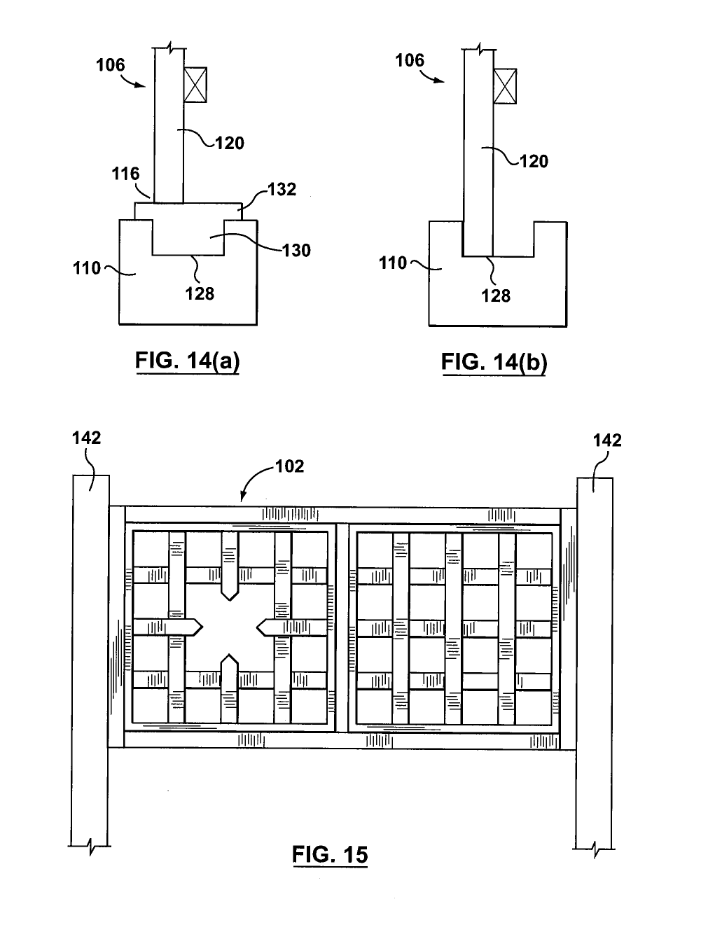

Reference is now made to FIG. 14(a), which illustrates a top view of a stile 110 mating with a design insert of FIGS. 7 and 8. A design insert 106 that includes a frame, as shown in FIGS. 3(a)-3(g), can be mated with the internal groove 128 of an insert-receiving space using a lip 132 and edge 130 as described above. The lattice-type internal member 120 is appropriately fastened to the external frame 116 of the design insert 106. FIG. 14(b) illustrates a top view of the mating between a frameless design insert 106 (as shown in FIGS. 3(h)-3(n)) and a structural frame (as shown in FIG. 2). In the absence of an external frame 116, mating between the design insert 106 and the structural frame may be accomplished by inserting the ends of the lattice-type internal members 120 into the groove 128 of the stile 110. The mating between a design insert 106 and a stile 110 has been described as a representative example, and it would be understood by anyone skilled in the art that a similar mating arrangement could exist between a design insert 106 and a rail 108 or mullion 112 (as shown in FIG. 1(a)).

Reference is now made to FIG. 15, which illustrates a panel 102 in one embodiment as part of a simple garden architectural system. The panel 102 may also be part of other architectural systems, such as a deck, patio or any other outdoor space. The panel 102, as shown, is attached to posts 142. Of course, it will be appreciated by those of skill in the art that the panel 102 may be part of more complex architectural systems and that other methods of support may be used. For example, panel 102 may be supported by building at one or both ends.

To assemble a panel in accordance with an embodiment of the invention, the desired appearance of the panel is first to be determined based on the option available given the modular panel assembly 100, and in particular the different design inserts 106 available in this modular panel assembly. Then, the particular structural members and design inserts required to construct such panel would be selected. The structural members and select design inserts 106 could then be assembled to provide the panel.

During assembly, additional means may be employed to strengthen the connections of the structural members with one another. For example, dowel could be used in both end protrusion 140 of any millions used to secure this end protrusion in the groove 128 with which it meets. That is, the dowel would fit into molding holes in both in protrusion 140 and groove 128. Similarly, dowel may be provided in end protrusion 138 of rail 108 that secures rail 108 in a groove 128 of stile 110. This dowel projecting from end protrusion 138, would then mate with a corresponding hole in the base of groove 128 of stile 110. Of course, other suitable securing means may be used, or, alternatively, the structural members may be simply glued together.

In the embodiments described above, the structural couplers of the structural members such as the rails 108 or stiles 110 are female couplers that provide groove 128 when the structural members are assembled, while the insert couplers of the design inserts 106 are male couplers. In the case of embodiments of the design inserts including an external frame 116, the male coupler can be the edge 130. In the case of embodiments of the design inserts lacking the external frame 116, the male couplers can be provided by the ends of the internal members of the design insert 106, such as, for example, the lattice-type internal members 120 of FIG. 3(h). However, it will be appreciated by those of skill in the art that the couplers used may not be male/female type couplers. It would be further understood that if male/female couplers are used, the structural couplers could be male couplers, in which case the design insert couplers would be female couplers. This is the case in the embodiment described below.

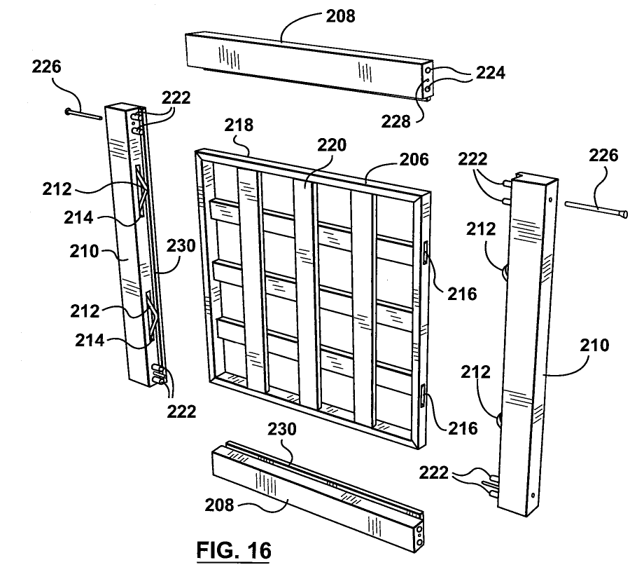

Referring to FIG. 16, there is illustrated in a perspective view, a panel assembly in accordance with a further embodiment of the present invention. The modular panel assembly 200 of FIG. 16 comprises two different types of components—the structural members on the one hand, and a design insert 206 on the other hand. In the embodiment shown, the structural members comprise rails 208 and stiles 210. These structural members can be assembled to provide an insert-receiving space for receiving the design insert 206. Variants of the embodiment shown in FIG. 16 may be provided using internal structural members such as millions to define multiple insert-receiving spaces. For example, the stile 210 on the right hand side of FIG. 16 could optionally be replaced with a mullion, and the rails 208 extended toward the right side of this Figure, while a further mullion or stile could be provided further to the right to define a second insert-receiving space to the right of the first insert-receiving space, Then a pair of design inserts 206 could be inserted into these insert-receiving spaces.

As shown in FIG. 16, the male couplers of the structural members are resilient members 212 mounted in slots 214. The resilient members comprise crests that, in the absence of a compressive force compressing the resilient members 12 into slots 214, project beyond slots 214. In the embodiment shown, the resilient members 212 and slots 214 are provided only in the stiles 210 and not in the rails 208. However, optionally, these structural couplers might be provided in the rails 208 and not in the stiles 210, or, alternatively, might be provided in both the rails 208 and the stiles 210. However, as will be described in more detail below, coupling only two of the four sides of the design insert 206 to the surrounding structural members is desirable as it facilitates removal of the design insert during disassembly, while the design insert 206 is held more securely if the two sides secured are opposite to one another.

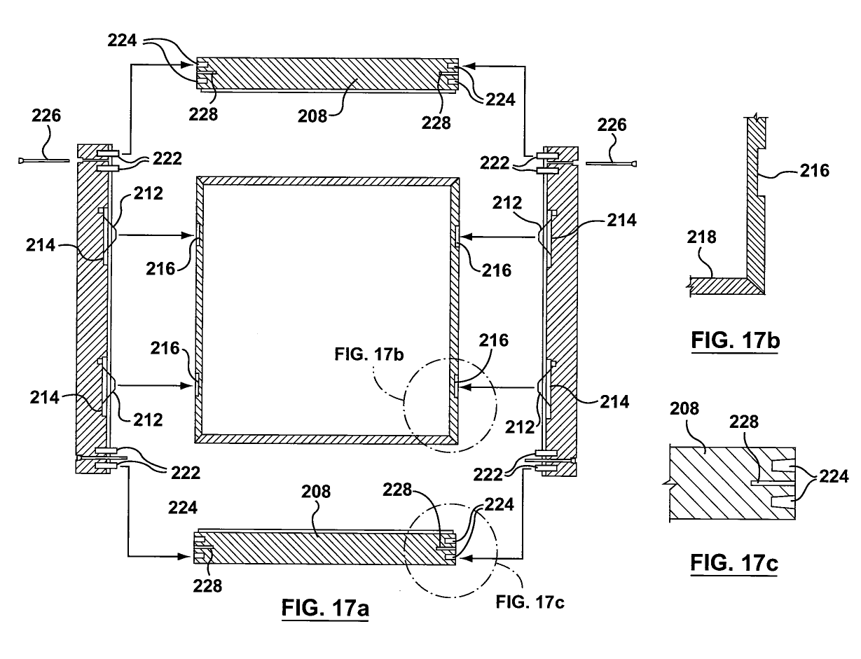

Design insert 206 comprises grooves dimensioned to receive the crests of the resilient members 212 of the stiles 210. To assemble the assembly 200 shown in FIG. 16, the structural members can first be assembled. Referring to FIG. 17a , the modular panel assembly 200 of FIG. 16 is illustrated in a schematic view. As shown in both FIGS. 16 and 17a , stiles 210 comprise dowels 222 that can be inserted into tapered holes 224 in rail 208. As shown most clearly in FIG. 17a , tapered holes 224 are tapered inwardly to grip dowels 222 more securely as dowels 222 are inserted further into holes 224. Once the stiles 210 and rails 208 have been assembled by mating the dowels 222 with the dowel-receiving holes 224, screws 226 can be threaded through stiles 210 and into screw-receiving hole 228 in rail 208 to secure the structural members together.

As best shown in FIG. 16, the structural members comprise a raised ridge 230, which will border the design insert 206 on one side only after assembly, such that the other side of the insert-receiving space is open for insertion or removal of the design insert 206. This facilitates insertion of the design insert 206 into the insert-receiving space defined by the structural members, as well as disassembly by removing the design insert 206 from this insert-receiving space. Specifically, in one mode of assembly the design insert 206 can be inserted into the insert-receiving space from the left such that the resilient members 212 of the right hand stile 210 fits into grooves 216 on the right hand side of the external frame 218. Then, the resilient members 212 of stile 210 on the left hand side of FIG. 16 can be pressed down into their respective slots to fit the left hand side of the design insert 206 into the insert-receiving space such that the slots 216 (shown in FIG. 17a ) on the left hand side of the design insert 206 align with resilient members 212 of the stile 210 on the left side of FIG. 16. When the force pressing the resilient members 212 down is removed, the resilient members 212 extend into grooves 216 to secure the design insert 206 in place. While the resilient members 212 are compressible into slots 214, they are relatively rigid and resist bending to either side of insert-receiving space into which they project, such that the resilient members form a barrier to the sides of grooves 216 to stop the design insert from falling out of the open side of the insert-receiving space.

By this means, design insert 206 can be held resiliently between two opposing pairs of resilient members 212, thereby securing the design insert 206 from inadvertently falling out, while at the same time, as will be described in more detail below, enabling the design insert 206 to be removed.

To remove the design insert 206, a pair of thin, rigid elements (wedge elements) can be used to advantage (these wedge elements may also be used to press down the resilient members during assembly as described above). In one mode of operation, the two wedge elements can be inserted on the open side of the juncture between the design insert 206 and the adjoining stile 210. As described above, the open side is the side lacking the ridge 230. Each wedge would be typically inserted either above or below the resilient member 212. Then, the wedge would be moved over the resilient member 212 to compress the resilient member 212 to move it out of groove 216, such that the right hand side of the design insert 206 is now free to be moved out of the insert-receiving space via the open side of the structural members. Once this is done, and the right hand side of the design insert is moved past the stile via the open side, the design insert 206 can simply be pulled away from the stile 210 on the left hand side of FIG. 16 to disengage the resilient members 212 of this stile 210 from the grooves 216 (shown in FIG. 17a ).

The design insert 206 found in FIG. 16 is merely one example of the design insert 206 that could be used. That is, this design insert could be replaced with other design inserts having an external frame 218 and different internal members extending between this external frame 218. Alternatively, design insert 206 might be replaced with another design insert that does not have an external frame 218 at all. In that case, grooves could be formed in the internal members themselves to engage the resilient members 212.

Referring to FIG. 17b , there is illustrated in an expanded view, a corner of the external frame 218 of the design insert 206. The portion shown also includes the groove 216 that receives the resilient member 212 (shown in FIG. 17a ).

Referring to FIG. 17c , an end of the rail 208 is illustrated in an expanded view. As shown, this end of rail 208 comprises the dowel-receiving tapered holes 224, as well as the screw-receiving hole 228. As shown, the dowel-receiving holes 224 are tapered.

The present invention has been described here by way of example only. For example, the lip 132 and edge 130 internal coupling features described with reference to an external frame 116 could also be applied to the ends of the lattice-type internal members 120 to create the internal couplings of frameless design inserts 106. In such an embodiment, the ends of the lattice-type internal members could be widened to span the width of the groove 128. Various modifications and variations may be made to these exemplary embodiments without departing from the spirit and scope of the invention, which is limited only by the appended claims.

1. A modular panel assembly comprising:
a) a plurality of structural members for assembling to define a plurality of insert-receiving spaces, wherein the plurality of structural members comprise a plurality of structural couplers for each insert-receiving space in the plurality of insert-receiving spaces; and,
b) a plurality of design inserts of a plurality of different design insert kinds, wherein
each design insert kind in the plurality of different design insert kinds has a distinct appearance, and
each design insert of the plurality of design inserts i) is receivable into a corresponding insert-receiving space in the plurality of insert-receiving spaces, ii) is of a corresponding design insert kind in the plurality of different design insert kinds, and, iii) comprises a configuration of design members to provide the distinct appearance of the corresponding design insert kind, the configuration of design members including a plurality of insert couplers for mating with the plurality of structural couplers to secure the design insert in the corresponding insert-receiving space, wherein the plurality of structural couplers and the plurality of insert couplers comprise a plurality of male members and a plurality of female members for mating with the plurality of male members;
such that when different design inserts are of different corresponding design insert kinds, the configurations of the different design members differ to provide the distinct appearances of the corresponding design insert kinds.

2. The assembly as defined in claim 1 wherein the plurality of male members are a plurality of resilient members and the plurality of female members are a plurality of grooves for receiving the plurality of resilient members.

3. The assembly as defined in claim 2 wherein after assembly, each design insert in the assembly
comprises a first side and a second side opposite to the first side; and,
is secured between at least one first-side resilient member in the plurality of resilient members and at least one second-side resilient member in the plurality of resilient members, the first-side resilient member being operable to resiliently push the first side of the design insert away from a structural member adjacent the first side, and the second-side resilient member being operable to resiliently push the second side of the design insert away from a structural member adjacent the second side.

4. The assembly as defined in claim 3 wherein the plurality of resilient members are secured in a plurality of slots.

5. The assembly as defined in claim 3 wherein the plurality of resilient members are deformable to, when the plurality of structural members are assembled to define the plurality of insert-receiving spaces, i) facilitate insertion of the plurality of design inserts into the plurality of insert-receiving spaces without disassembly of the plurality of structural members; and ii) facilitate removal of the plurality of design inserts from the plurality of insert-receiving spaces without disassembly of the plurality of structural members.

6. The assembly as defined in claim 3 wherein the plurality of structural couplers are the plurality of resilient members and the plurality of insert couplers are the plurality of grooves.

7. The assembly as defined in claim 3 wherein
the plurality of design inserts comprises design inserts of different sizes; and,
the plurality of structural members comprises structural members of different sizes operable to form insert-receiving spaces of different sizes to accommodate the design inserts of different sizes.

8. A modular panel assembly comprising;
a) a plurality of structural members for assembling to a define an insert-receiving space, wherein the plurality of structural members comprise a plurality of resilient members projecting into the insert-receiving space;
b) a design insert for insertion into the insert-receiving space, the design insert having a plurality of grooves for receiving the plurality of resilient members to secure the design inserts in the corresponding insert receiving space.

9. The modular panel assembly is defined in claim 8 wherein the plurality of resilient members are deformable to, when the plurality of structural members are assembled to define the insert-receiving space, i) facilitate insertion of the design insert into the insert-receiving space without disassembly of the plurality of structural member; and, ii) facilitate removal of the design insert from the insert-receiving space without disassembly of the structural member.

10. The assembly as defined in claim 9 wherein the plurality of resilient members are secured in a plurality of slots in the plurality of structural members, such that a plurality of crests of the plurality of resilient members project out of the plurality of slots to engage the plurality of grooves; the plurality of resilient members are compressibly deformable to push the plurality of crests into the plurality of slots to facilitate insertion and removal of the design insert into the insert-receiving space.
